(19) United States
(12) Patent Application Publication
(10) Pub. No.: US 2007/0124512 A1
(43) Pub. Date: May 31, 2007

(54) Method of setting print port and user terminal device using the same

(75) Inventor: Jae-hyun Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/528,390

(22) Filed: Sep. 28, 2006

(30) Foreign Application Priority Data
Nov. 21, 2005 (KR) 2005-111203

(51) Int. Cl. G06F 3/00

(52) U.S. Cl. 710/8

(57) ABSTRACT

A method of setting a print port and a user terminal device using the same includes transmitting, in a single transmission, a searching signal including network information and device information of an image forming device which is a desired one of a plurality of image forming devices, and setting a print port of the image forming device by the network information, if an answer signal with respect to the searching signal is received. Accordingly, it is possible to easily deal with a change in the network information of the image forming device.

### CROSS-REFERENCE TO RELATED APPLICATIONS

This application claims priority under 35 U.S.C. § 119(a) from Korean Patent Application No. 2005-111203, filed Nov. 21, 2005, in the Korean Intellectual Property Office, the entire contents of which are incorporated herein by reference.

### BACKGROUND OF THE INVENTION

1. Field of the Invention

The present general inventive concept relates to a method of setting a print port and a user terminal device using the same. More particularly, the present general inventive concept relates to a method of setting a print port and a user terminal device using the same, which enables to promptly deal with network information changes of an image forming device connected through a network.

2. Description of the Related Art

Various input and output devices are more increasingly used for office automation, and an image forming device, such as a laser beam printer, an LPH (LED Print Head) printer, a duplicator and a facsimile is used as one of the input and output devices.

A conventional image forming device has individual functions, such as printing or duplicating, scanning and faxing independently existing in one device. In a recently developed image forming device, various functions are integrated into one device, and it is referred to as a multi-function printer (MFP).

The conventional image forming device is locally connected with one user terminal device. However, with advanced network such as a local area network (LAN), one or more user terminal devices and one or more image forming devices are connected with the same network.

FIG. 1 is a view illustrating a conventional method of registering an image forming device.

Referring to FIG. 1, in a network environment where one user terminal device 10, one service providing server 20, and a plurality of image forming devices 30a through 30n are connected through the same network, for example, a LAN (local area network).

The user terminal device 10 is provided with service information and corresponding device information from the service providing server 20 and the plurality of image forming devices 30a through 30n. The user terminal device 10 may be a general personal computer.

The service providing server 20 processes information about all the devices connected through the LAN, and provides the corresponding service information according to a request from the user terminal device 10.

The plurality of image forming devices 30a through 30n provides their device information according to a request from the user terminal device 10 or the service providing server 20 connected with the plurality of image forming devices 30a through 30n through the LAN.

In the network environment, the user terminal device 10 may request a service in a unicast when being aware of network information of a device providing its desired service, and may request a service in a multicast when being unaware of network information of a device providing its desired service.

The service providing server 20 requested with the service or the plurality of image forming devices 30a through 30n transmit a response packet to the request for the service to the user terminal device 10. However, the response packet is not transmitted when the corresponding service fails to be provided.

Accordingly, the user terminal device 10 can not know which device receives the desired service, among the service providing server 20 and the plurality of image forming devices 30a through 30n.

When there are changes in the network information of the service providing server 20 and the plurality of image forming devices 30a through 30n, the user terminal device 10 can not recognize the changes. Before manually resetting the network information, it is unable to use the service providing server 20 and the plurality of image forming devices 30a through 30n.

### SUMMARY OF THE INVENTION

Accordingly, an aspect of the present general inventive concept provides a method of setting a print port and a user terminal device using the same, which enables an automatic update of network information, when there is a change in the network information with respect to a particular image forming device registered to the user terminal device.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of setting a print port, the method comprising transmitting, in a single transmission, a searching signal including network information and device information of one of a plurality of image forming devices, and setting a print port of the image forming device by the network information, if an answer signal with respect to the searching signal is received.

The predetermined protocol may be a service location protocol (SLP).

The method may further comprise receiving the network information and the device information of the one of the plurality of image forming devices from a user.

The method may further comprise periodically transmitting the searching signal to the image forming device whose print port is set, and confirming whether the network information of the image forming device changes or not, by the network information including an answer signal with respect to the searching signal.

The method may further comprise transmitting the searching signal including the device information to the plurality of image forming devices in a group transmission, unless the answer signal with respect to the searching signal is not received for a predetermined time; and resetting the print port of the image forming device by the network information included in the received answer signal, when the answer signal with respect to the searching signal transmitted in the group transmission, is received.

The group transmission may be one of a multicast and a broadcast.

The foregoing and/or other aspects of the present general inventive concept may also be achieved by providing a user terminal device to set a print port, comprising a searching signal generating unit to generate a searching signal including network information and device information of one of a plurality of image forming devices, a network interfacing unit transmit the generated searching signal in a unicast transmission and receiving an answer signal with respect to the searching signal, and a driver setting unit to register the image forming device to be usuable, by the network information when the answer signal is received through the network interfacing unit.

The predetermined protocol may be a service location protocol (SLP).

The user terminal device may further comprise a user inputting unit to receive from a user the network information and the device information of the one of the plurality of image forming devices.

The user terminal device may further comprise a controlling unit to control the searching signal to be periodically transmitted through the network interfacing unit, and to confirm whether the network information of the registered image forming device changes or not, by the network information included in the answer signal with respect to the searching signal.

The controlling unit may control the searching signal including the device information to be transmitted to the plurality of image forming devices in a group transmission, unless the answer signal with respect to the searching signal is received through the network interfacing unit for a predetermined time.

The controlling unit may control the driver setting unit to reregister the image forming device by the network information included in the received answer signal, when the answer signal with respect to the searching signal transmitted in the group transmission, is received.

The group transmission may be one of a multicast and a broadcast.

The foregoing and/or other aspects of the present general inventive concept may also be achieved by providing computer readable recording medium containing computer readable codes to perform a method, the method including transmitting, in a single transmission, a searching signal including network information and device information of an image forming device as a desired one of a plurality of image forming devices, and setting a print port of the image forming device by the network information, if an answer signal with respect to the searching signal is received.

The method of the computer readable recording medium may further comprise transmitting the searching signal including the device information to the plurality of image forming devices in a group transmission, if the answer signal with respect to the searching signal is not received for a predetermined time in the signal transmission.

The foregoing and/or other aspects of the present general inventive concept may also be achieved by providing a user terminal device connected with a plurality of image device devices through a predetermined protocol, the user terminal device including a searching signal generating unit to generate a first searching signal including network information and device information and a second searching including the device information, and an interfacing unit to transmit one of the first searching signal and the second searching signal to an external device to obtain a response from the external device.

The foregoing and/or other aspects of the present general inventive concept may also be achieved by providing a method of a user terminal device connected with a plurality of image device devices through a predetermined protocol, the method including generating a first searching signal including network information and device information and a second searching including the device information, and transmitting one of the first searching signal and the second searching signal to an external device according to a response state of the external device.

The method may further include setting a print port to be assigned to the external device according to a response from the external device in response to the one of the first searching signal and the second search signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional method of registering an image forming device;

FIG. 2 is a block diagram illustrating a user terminal device according to an embodiment of the present general inventive concept;

FIG. 3 is a view illustrating a signal flow between an image forming device and the user terminal device of FIG. 2;

FIG. 4 is a view illustrating a method of registering an image forming device at a user terminal device; and

FIG. 5 is a flowchart illustrating a method of registering network information of an image forming device according to the embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the following description, well-known functions or constructions are not described in detail since they would obscure the invention in unnecessary detail.

FIG. 2 is a block diagram illustrating a user terminal device 100 according to an embodiment of the present general inventive concept.

Referring to FIG. 2, the user terminal device 100 includes a user inputting unit 110, a searching signal generating unit 120, a network interfacing unit 130, a driver setting unit 140, a storing unit 150, and a controlling unit 160.

The user terminal device 100 is connected with a plurality of image forming devices through a predetermined network, for example, a local area network (LAN), and one of the plurality of image forming devices is designated as a basic printer, a desired printer, or a default printer. When the basic printer is designated, the user terminal device 100 sets a print port to be applied to a corresponding image forming device in printing.

The user inputting unit 110 receives network information and device information of one of the plurality of image forming devices. A user may input a type of a port to be set with respect to a particular image forming device, to the user inputting unit 110.

The network information includes an Internet protocol (IP) address. The native IP address is assigned to each device, and may be used to search a particular image forming device.

The device information may be used to search one of the plurality of image forming devices. The one of the plurality of image forming devices may be required to meet a predetermined condition set by a user or a printing condition. For example, the device information corresponding to a color printer or a black-and-white printer is input to be used to search one or more corresponding printers.

The searching signal generating unit 120 generates a searching signal including the network information and the device information of a desired one of the plurality of image forming devices, which are received from the user inputting unit 110.

When the searching signal is transmitted in a unicast, the searching signal generating unit 120 generates a unicast packet with respect to the searching signal under the control of the controlling unit 160. When the searching signal is transmitted in a multicast or broadcast, the searching signal generating unit 120 generates a multicast packet or a broadcast packet with respect to the searching signal under the control of the controlling unit 160 mentioned later. Here, the unicast indicates that the searching signal is transmitted to a designated device defined in at least one of the network information and the device information, and the multicast indicates that the searching signal is transmitted to a plurality of devices one of which may be a desired device defined in at least one of the network information and the device information.

The network interfacing unit 130 transmits the multicast or the broadcast packet generated by the searching signal generating unit 120 under the control of the controlling unit 160 according to a corresponding transmission method. The network interfacing unit 130 receives an answer signal transmitted from the image forming device connected through the network.

The driver setting unit 140 sets the print port of the image forming device by the network information, when the answer signal is received through the network interfacing unit 130. The reception of the answer signal indicates that the network information received through the user inputting unit 110 is accurate and the searching signal is precisely transmitted to the corresponding image forming device.

The storing unit 150 may store the network information and the device information received from the user inputting unit 110. The storing unit 150 may store information related to various image forming devices set by the driving setting unit 140.

The controlling unit 160 controls overall functions of the user terminal device 100. That is, the controlling unit 160 controls signal input and output among the user inputting unit 110, the searching signal generating unit 120, the network interfacing unit 130, the driver setting unit 140, and the storing unit 150.

The controlling unit 160 may control the searching signal generating unit 120 to periodically transmit the searching signal through the network interfacing unit 130. The controlling unit 160 may confirm whether there is a change in the network information of the image forming device set with the print port, by address information included in the answer signal with respect to the searching signal.

The controlling unit 160 may control the searching signal generating unit 120 to periodically transmit the searching signal including only the device information to the plurality of image forming devices in the multicast, unless the answer signal to the searching signal is received through the network interfacing unit 130 for a predetermined time.

The controlling unit 160 controls the driver setting unit 140 to reregister the image forming device by the network information included in the received answer signal, when there is the received answer signal respect to the searching signal transmitted in the multicast through the network interfacing unit 130. The registered image forming device may be stored in the storing unit 150.

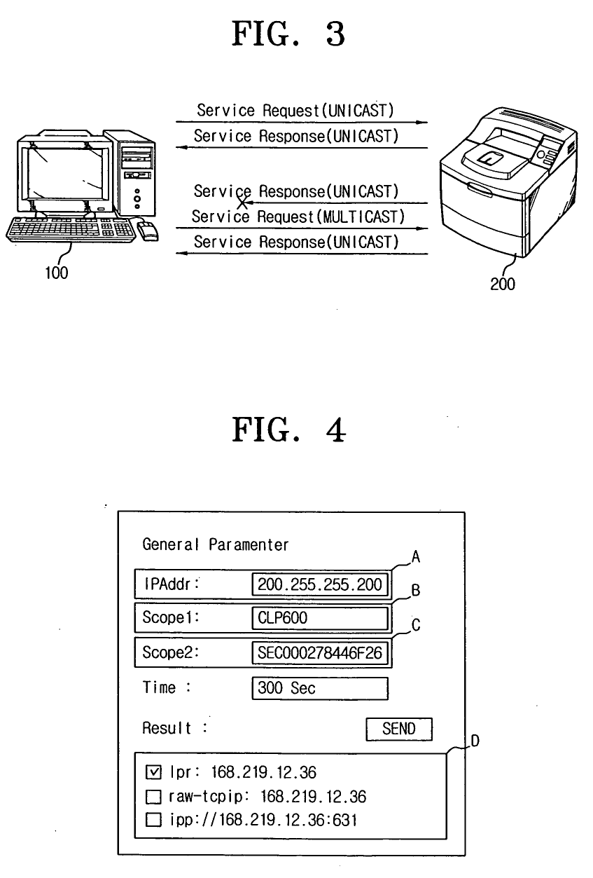

FIG. 3 is a view illustrating a signal flow between an image forming device 200 and the user terminal device 100 of FIG. 2.

According to the present embodiment, a communication is performed by use of a service location protocol (SLP) between the user terminal device 100 and the image forming device 200. The SLP uses a “service request” packet in order to search one or more devices connected through the network or request a service to the one or more devices.

Referring to FIGS. 2 and 3, the user terminal device 100 transmits the image forming device 200 the “service request” packet which is the searching signal including the network information and the device information of a desired image forming device, which may be one of the plurality of image forming devices connected through the network. It is possible that the user terminal device 100 is aware of the network information of the image forming device 200 as the desired image forming device.

When the “service request” packet is received from the user terminal device 100, the image forming device 200 transmits a “service response” packet which is an answer signal with respect to the “service request” packet.

When the user terminal device 100 receives the “service response” packet from the image forming device 200, the print port of the image forming device 200 is set according to the network information, because it is judged that the user terminal device 100 possesses the accurate network information.

The user terminal device 100 periodically transmits the image forming device 200 the “service request” packet. The “service request” packet and the “service response” packet are transmitted and received between the user terminal device 100 and the image forming device 200, as long as the network information of the image forming device 200 is not changed.

If the “service response” packet is not received from the image forming device 200 although the “service request” packet is transmitted, the user terminal device 100 transmits the “service request” packet with respect to the searching signal including the only device information without the network information, in the multicast.

The “service response” packet is, in the unicast, transmitted by the image forming device 200 corresponding the device information included in the “service request” packet, among the plurality of image forming devices.

The user terminal device 100 may receive the “service response” packet from one or more image forming devices, and select one thereof, to set the print port.

FIG. 4 is a view illustrating a method of registering an image forming device at a user terminal device.

Referring to FIGS. 2-4, the image forming device 200 requires a driver program with respect to the corresponding image forming device to be installed at the user terminal device 100. The driver setting unit 140 may set the driver program at a user's option or under the control of the controlling unit 160.

According to the present embodiment, for example, a user interface (UI may be provided to the user to set the driver program through the driver setting unit 140. The user may input information relating to the image forming device to be registered, for example, the network information, the device information and the port to be used.

In the UI, a section A “IPAddr” is an IP for multicast. A section B “scope1” and a section C “scope2” are to designate a scope of the image forming device to receive the searching signal, and input the device information.

A port selecting unit (D) is displayed with a list of ports usable at the corresponding image forming device and the user may select a desired port. An “Ipr” is an IP for using 515 port, a “raw-tcpip” is an IP address for using 9100 port, and an “ipp” is an IP address for using an Internet printing protocol.

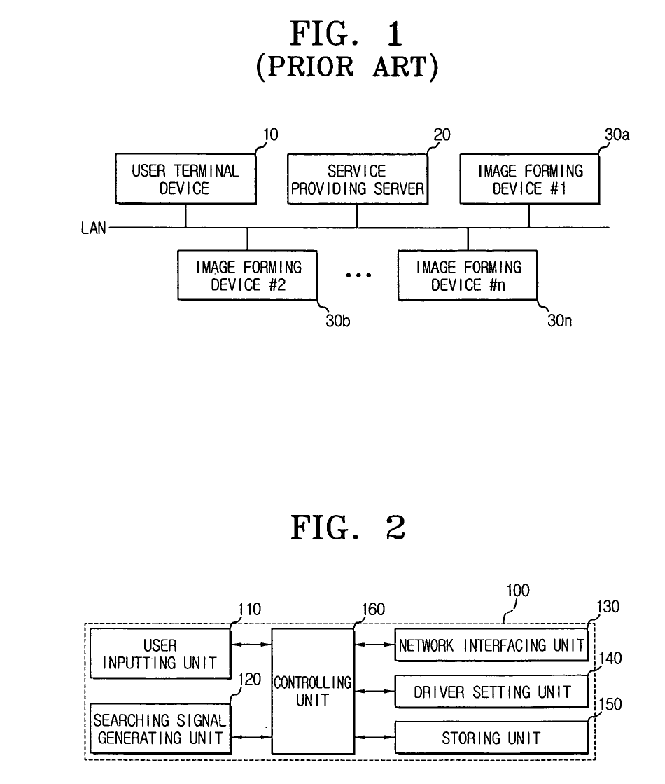

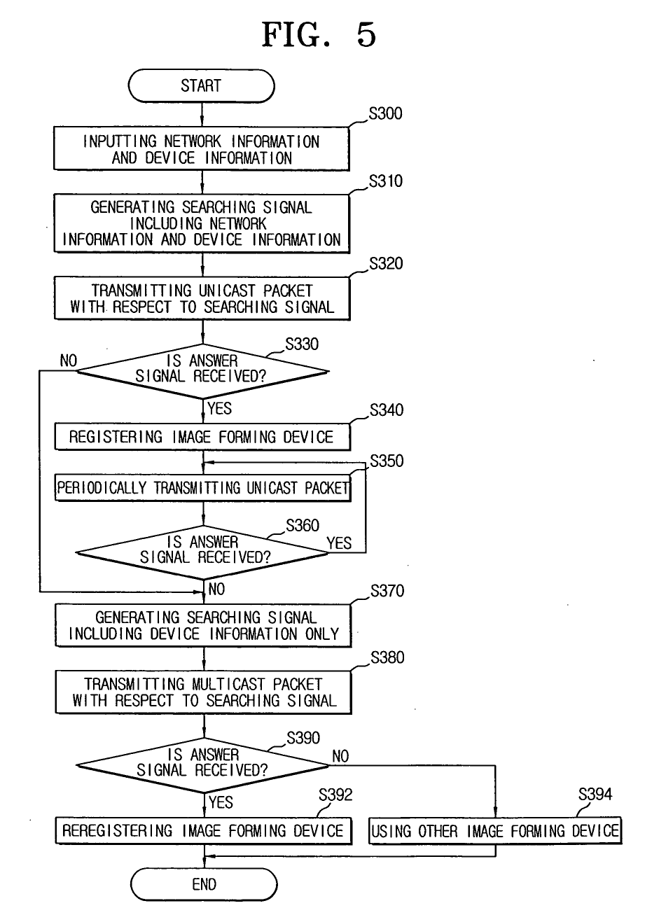

FIG. 5 is a flowchart illustrating a method of registering network information of an image forming device according to the embodiment of the present general inventive concept. The method of registering the network information of the image forming device will be described with reference to FIGS. 1 through 5.

The user inputs the network information and the device information with respect to the image forming device which is a desired one to be used for a printing operation, through the user inputting unit 110. It may be performed through the UI indicated in FIG. 4, to input the network information and the device information (S300).

The searching signal generating unit 120 generates the searching signal including the network information and the device information. The controlling unit 160 controls the searching signal generating unit 120 to generate a unicast packet with respect to the searching signal (S310).

If the unicast packet with respect to the searching signal is generated by the searching signal generating unit 120, the controlling unit 160 controls the network interfacing unit 130 to transmit the unicast packet with respect to the generated searching signal. The network interfacing unit 130 transmits the unicast packet with respect to the searching signal to a corresponding image forming device (S320).

If the answer signal is received from the image forming device (S330-Y), the driver setting unit 140 uses the network information and sets the print port of the corresponding image forming device (S340).

After the image forming device is registered, the controlling unit 160 controls the unicast packet with respect to the searching signal to be transmitted at predetermined time intervals preset through the network interfacing unit 130 (S350). That is, the unicast packet is periodically transmitted through the network interfacing unit 130.

If the image forming device normally receives the unicast packet with respect to the searching signal in the operation of 350, the image forming device transmits the answer signal. If the image forming device fails to normally receive the unicast packet due to reasons such as change in IP address of the image forming device, the answer signal is not received by the user terminal device 100 (S360-N).

If the answer signal is not received through the network interfacing unit 130, the controlling unit 160 judges that the network information of the image forming device changes, and controls the searching signal generating unit 120 to generate a multicast packet with respect to the searching signal including only the device information (S370).

The multicast packet with respect to the searching signal generated by the searching signal generating unit 120 is transmitted to the plurality of image forming devices through the network interfacing unit 130 (S380).

The plurality of image forming devices transmit the answer signal to the user terminal device 100, when the device information corresponds to the information thereof. When the answer signal is received (S390-Y), the user terminal device 100 uses the received network information of the image forming device and reregister the image forming device (S392).

When the multicast packet is transmitted but the answer signal is not received (S390-N), the user terminal device 100 uses other image forming device which is not previously used (S394).

In this process, it is possible to confirm the change in the network information of the image forming device through a consistent communication with the image forming device whose print port is set, and easily update the network information.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As abovementioned, according to an embodiment of the present general inventive concept, a method of setting a print port and a user terminal device using the same periodically exchange the network information with a pre-registered image forming device, so that the print port does not need to be reset every time the network information such as the IP address changes, and it is possible to promptly recognize the change in the network information.

By transmitting the searching signal in a multicast or a broadcast transmission, it is possible to easily know whether the user terminal device is connected with the image forming device desired to use through network or not, and to conveniently search other image forming device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of setting a print port of a user terminal device connected with a plurality of image forming devices through a predetermined protocol, the method comprising:
transmitting, in a single transmission, a searching signal including network information and device information of an image forming device as a desired one of a plurality of image forming devices; and
setting a print port of the image forming device by the network information, if an answer signal with respect to the searching signal is received.

2. The method of claim 1, wherein the predetermined protocol is a service location protocol (SLP).

3. The method of claim 1, further comprising:
receiving the network information and the device information of the image forming device according to a user preference.

4. The method of claim 1, further comprising:
periodically transmitting the searching signal to the image forming device whose print port is set, and confirming whether the network information of the image forming device is changed, by the network information including an answer signal with respect to the searching signal.

5. The method of claim 4, further comprising:
transmitting the searching signal including the device information to the plurality of image forming devices in a group transmission, if the answer signal with respect to the searching signal is not received for a predetermined time; and
resetting the print port of the image forming device by the network information included in the received answer signal, when the answer signal with respect to the searching signal transmitted in the group transmission, is received.

6. The method of claim 5, wherein the group transmission comprises one of a multicast and a broadcast.

7. A user terminal device connected with a plurality of image device devices through a predetermined protocol, the user terminal device comprising:
a searching signal generating unit to generate a searching signal including network information and device information of an image forming device as a desired one of a plurality of image forming devices;
a network interfacing unit to transmit the generated searching signal in a unicast transmission and to receive an answer signal with respect to the searching signal; and
a driver setting unit to register the image forming device to be used for a printing operation, by the network information when the answer signal is received through the network interfacing unit.

8. The user terminal device of claim 7, wherein the predetermined protocol is a service location protocol (SLP).

9. The user terminal device of claim 7, further comprising:
a user inputting unit to receive the network information and the device information of the image forming device among the plurality of image forming devices according to a user preference.

10. The user terminal device of claim 7, further comprising:
a controlling unit to control the searching signal to be periodically transmitted through the network interfacing unit, and to confirm whether the network information of the registered image forming device is changed, by the network information included in the answer signal with respect to the searching signal.

11. The user terminal device of claim 10, wherein the controlling unit controls the searching signal including the device information to be transmitted to the plurality of image forming devices in a group transmission, if the answer signal with respect to the searching signal is not received through the network interfacing unit for a predetermined time.

12. The user terminal device of claim 10, wherein the controlling unit controls the driver setting unit to reregister the image forming device according to the network information included in the received answer signal, when the answer signal with respect to the searching signal transmitted in the group transmission, is received.

13. The user terminal device of claim 11, wherein the group transmission comprises one of a multicast and a broadcast.

14. A computer readable recording medium containing computer readable codes to perform a method, the method comprising:
transmitting, in a single transmission, a searching signal including network information and device information of an image forming device as a desired one of a plurality of image forming devices; and
setting a print port of the image forming device by the network information, if an answer signal with respect to the searching signal is received.

15. The computer readable recording medium of claim 14, further comprising:
transmitting the searching signal including the device information to the plurality of image forming devices in a group transmission, if the answer signal with respect to the searching signal is not received for a predetermined time in the signal transmission.

16. A user terminal device connected with a plurality of image device devices through a predetermined protocol, the user terminal device comprising:
a searching signal generating unit to generate a first searching signal including network information and device information and a second searching including the device information; and
an interfacing unit to transmit one of the first searching signal and the second searching signal to an external device to obtain a response from the external device.

17. The user terminal device of claim 16, further comprising:
a controlling unit to control the searching signal generating unit to generate one of the first searching signal and the second searching signal.

18. The user terminal device of claim 16, further comprising:
a controlling unit to control the searching signal generating unit to generate the second searching signal as the one of the first searching signal and the second searching signal according to a response state of the external device.

19. The user terminal device of claim 16, further comprising:
a controlling unit to control the searching signal generating unit to generate the first searching signal to the external device, and to generate the second searching signal according to a response state from the external device in response to the first searching signal.

20. The user terminal device of claim 16, further comprising:
a controlling unit to control the interface unit to periodically transmit the one of the first searching signal and the second searching signal to update the network information on the external device.

21. The user terminal device of claim 16, further comprising:
a controlling unit to register the external device according to a response to the one of the first searching signal and the second searching signal.

22. The user terminal device of claim 16, further comprising:
a controlling unit to control the interface unit to transmit the first searching signal to the external device and to transmit the second searching signal to a plurality of external devices including the external device.

23. The user terminal device of claim 16, further comprising:
a controlling unit to set a print port to be assigned to the external device according to a response from the external device in response to the one of the first searching signal and the second search signal.

24. The user terminal device of claim 16, further comprising:
a controlling unit to receive second network information from the external device and to set a print port for the external device.

25. The user terminal device of claim 16, further comprising:
a controlling unit to receive second network information from the external device according to a response from the external device and to update the network information with the second network information.

26. The user terminal device of claim 25, wherein the controlling unit sets a print port according to at least one of the network information and the second network information, and does not rest the print port in response to a next communication with the external device.

27. The user terminal device of claim 16, wherein the response state of the external device comprises a non-response state from the external device.

28. The user terminal device of claim 16, wherein the external device comprises an image forming device

29. A method of a user terminal device connected with a plurality of image device devices through a predetermined protocol, the user terminal device comprising:
generating a first searching signal including network information and device information and a second searching including the device information; and
transmitting one of the first searching signal and the second searching signal to an external device according to a response state of the external device.

30. The method of claim 29, further comprising:
setting a print port to be assigned to the external device according to a response from the external device in response to the one of the first searching signal and the second search signal.
